(19) United States
(12) Patent Application Publication
(10) Pub. No.: US 2026/0233658 A1
(43) Pub. Date: Aug. 13, 2026

(54) EXPANDABLE MODULAR VEHICLE FOR LIFTING AND TRANSPORTING CARGO PALLETS

(71) Applicant: GM Global Technology Operations LLC, Detroit, MI (US)

(72) Inventor: Wade W. Bryant, Grosse Point Farms, MI (US)

(73) Assignee: GM Global Technology Operations LLC, Detroit, MI (US)

(21) Appl. No.: 19/049,502

(22) Filed: Feb. 10, 2025

(51) Int. Cl. B60P 1/44; B60D 1/01; B60P 3/32; B60Q 1/26; B62D 9/00; B62D 13/00

(52) U.S. Cl. CPC B60P 1/4485; B60D 1/01; B60P 1/4471; B60P 3/32; B60Q 1/26; B62D 9/002; B62D 13/005

(57) ABSTRACT

A vehicle has a body including a chamber and a lifting mechanism disposed at least partially within the chamber and configured to engage and lift a cargo pallet. The chamber is configured to receive the cargo pallet through an opening in the body and accommodate the cargo pallet and the lifting mechanism. A propulsion system includes first and second independently driven wheels disposed at opposing sides of the body and is configured to drive the first and second wheels to cause the vehicle to pivot about a rotational axis. A bi-directional hitch is disposed at an upper portion of the body and includes first and second connectors that are configured to pivot relative to one another and relative to the body about the rotational axis of the vehicle. Each of the first and second connectors is configured to attach the vehicle to one of another vehicle and a trailer.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a modular vehicle system for lifting and transporting cargo pallets within environments and between destinations. Cargo pallets are a standard packaging unit where one or more items or objects are attached to a pallet for space-efficient transportation and compatibility with standardized lifting apparatuses like forklifts. Typically, cargo pallets are moved within an environment via forklifts and loaded onto separate vehicles, like semi-trucks or box trucks, for transportation between other destinations. Once the transportation vehicle arrives at the final destination, the cargo pallets are removed via additional forklifts. Thus, shipping cargo pallets typically requires use of a forklift both at the cargo's origin and at the cargo's final destination.

### SUMMARY

One aspect of the disclosure provides a vehicle including a body, a propulsion system, and a bi-directional hitch. The body includes a chamber and a lifting mechanism. The lifting mechanism is disposed at least partially within the chamber and configured to engage and lift a cargo pallet. The chamber is configured to receive the cargo pallet through an opening in the body and accommodate the cargo pallet and the lifting mechanism within the chamber. The propulsion system includes a first independently driven wheel and a second independently driven wheel disposed at opposing sides of the body. The propulsion system is configured to drive the first wheel and the second wheel to cause the vehicle to pivot about a rotational axis of the vehicle. The bi-directional hitch is disposed at an upper portion of the body and includes a first connector and a second connector. The first connector and the second connector are configured to pivot relative to one another and relative to the body about the rotational axis of the vehicle. Each of the first connector and the second connector is configured to attach the vehicle to one of another vehicle and a trailer.

Implementations of the disclosure may include one or more of the following optional features. In some implementations, the lifting mechanism is configured to extend at least partially through the opening in the body and away from the chamber. In further implementations, with the vehicle attached to the trailer, the lifting mechanism is configured to extend through the opening in the body and at least partially through an opening in the trailer to deposit the cargo pallet within an interior portion of the trailer.

In some examples, the body includes a second chamber and a second lifting mechanism disposed at least partially within the second chamber and configured to engage and lift a second cargo pallet. The second chamber is configured to receive the second cargo pallet through a second opening in the body and accommodate the second cargo pallet and the second lifting mechanism within the second chamber.

In some aspects, the propulsion system is configured to drive the vehicle in a forward direction of travel and a rearward direction of travel. In further aspects, a first indicator light is disposed at a first exterior side of the body and a second indicator light is disposed at a second exterior side of the body opposite the first exterior side. The first indicator light and the second indicator light are switchable between operating as a headlamp for the vehicle and operating as a taillamp for the vehicle based on a current direction of travel of the vehicle.

In some implementations, each of the first connector and the second connector is further configured to attach to an accessory attachment. In some examples, the vehicle is configured to attach to the selected one of the other vehicle and the trailer to form a road train, and the propulsion system of the vehicle is configured to drive the road train in a direction of travel. In some aspects, the body includes a cab configured to accommodate a driver of the vehicle. Optionally, the vehicle further includes a sensor system configured to capture sensor data at the vehicle to enable at least partially autonomous driving of the vehicle.

Another aspect of the disclosure provides a road train. The road train includes a first vehicle and a second vehicle connected together. Each of the first vehicle and the second vehicle includes a body, a propulsion system, and a bi-directional hitch. The body includes a chamber and a lifting mechanism. The lifting mechanism is disposed at least partially within the chamber and configured to engage and lift a cargo pallet. The chamber is configured to receive the cargo pallet through an opening in the body and accommodate the cargo pallet and the lifting mechanism within the chamber. The propulsion system includes a first independently driven wheel and a second independently driven wheel disposed at opposing sides of the body. The propulsion system is configured to drive the first wheel and the second wheel to cause the respective vehicle to pivot about a rotational axis of the vehicle. The bi-directional hitch is disposed at an upper portion of the body and includes a first connector and a second connector. The first connector and the second connector are configured to pivot relative to one another and relative to the body about the rotational axis of the respective vehicle. Each of the first connector and the second connector is configured to attach the respective vehicle to one of another vehicle and a trailer. With the first vehicle disposed in a front position of the road train, at least the propulsion system of the first vehicle is configured to drive the road train in a direction of travel. This aspect may include one or more of the following optional features.

In some implementations, the first vehicle is attached at a first connector of the trailer and the second vehicle is attached at a second connector of the trailer. In further implementations, the trailer is supported between the first vehicle and the second vehicle. In even further implementations, the trailer includes a support element configured to extend from the trailer and support the trailer at a ground surface. The support element includes at least one selected of a caster, a support leg, and a lower portion of the trailer. Optionally, the respective propulsion systems of the first vehicle and the second vehicle are configured to drive the road train in the direction of travel.

Yet another aspect of the disclosure provides a system. The system includes a first vehicle and a second vehicle connected to one another in a road train. Each of the first vehicle and the second vehicle includes a body, a propulsion system, and a bi-directional hitch. The body includes a chamber and a lifting mechanism. The lifting mechanism is disposed at least partially within the chamber and configured to engage and lift a cargo pallet. The chamber is configured to receive the cargo pallet through an opening in the body and accommodate the cargo pallet and the lifting mechanism within the chamber. The propulsion system includes a first independently driven wheel and a second independently driven wheel disposed at opposing sides of the body. The propulsion system is configured to drive the first wheel and the second wheel to cause the respective vehicle to pivot about a rotational axis of the vehicle. The bi-directional hitch is disposed at an upper portion of the body and includes a first connector and a second connector. The first connector and the second connector are configured to pivot relative to one another and relative to the body about the rotational axis of the respective vehicle. Each of the first connector and the second connector is configured to attach the respective vehicle to one of another vehicle and a trailer. The system includes memory hardware storing instructions that, when executed on data processing hardware in communication with the memory hardware, cause the data processing hardware to perform operations. The operations include, with the first vehicle disposed in a front position of the road train, operating at least the propulsion system of the first vehicle to drive the road train in a direction of travel. This aspect may include one or more of the following optional features.

In some implementations, the operations further include, with the second vehicle in a rear position of the road train, operating the second connector of the second vehicle to attach the second vehicle to the selected one of the other vehicle and the trailer based on a destination of the selected one of the other vehicle and the trailer. In some examples, the operations further include, with the second vehicle in a rear position of the road train, operating the first connector of the second vehicle to detach the second vehicle from the road train based on a destination of the second vehicle. In some aspects, the operations further include, with the first vehicle disposed in the front position of the road train, operating the first connector of the first vehicle to attach the first vehicle to another vehicle and operating at least a propulsion system of the other vehicle to drive the road train in the direction of travel. Optionally, the operations include operating the respective propulsion systems of the first vehicle and the second vehicle to drive the road train in the direction of travel.

The details of one or more implementations of the disclosure are set forth in the accompanying drawings and the description below. Other aspects, features, and advantages will be apparent from the description, and from the claims.

### BRIEF DESCRIPTION OF THE DRAWINGS

The drawings described herein are for illustrative purposes only of selected configurations and are not intended to limit the scope of the present disclosure.

FIG. 1 is a perspective view of a road train having a front vehicle and a rear vehicle connected together, with a lifting mechanism of the front vehicle operating to load a cargo pallet onto a flatbed truck.

FIG. 2 is a perspective view of a road train having a trailer connected to the front vehicle, with the front vehicle pivoting relative to the trailer.

FIG. 3 is a perspective view of a bi-directional hitch assembly of one vehicle of the road train.

FIG. 4 is a sectional view of the vehicle with an overlay of the hitch assembly.

FIG. 5 is a perspective view of the road train having an accessory attachment attached to a connector of the hitch assembly of the front vehicle and operating to unload cargo from a cargo pallet.

FIG. 6 is a perspective view of a road train having a trailer disposed between the front vehicle and the rear vehicle, with the lifting mechanism of the front vehicle extended from the cargo area of the front vehicle.

FIG. 7 is a perspective view of a road train having the front vehicle, the rear vehicle, and an intermediate vehicle between the front vehicle and the rear vehicle.

FIG. 8 is a schematic view of the road train showing individual vehicles of the road train flexing or pivoting relative to one another.

FIGS. 9A-9C are perspective views of the road train showing the front vehicle pivoting relative to the rear vehicle to expose a cargo area of the front vehicle.

FIG. 10 is a schematic view of an environment in which a plurality of road trains are operating to pick up, transport, and deliver cargo pallets.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

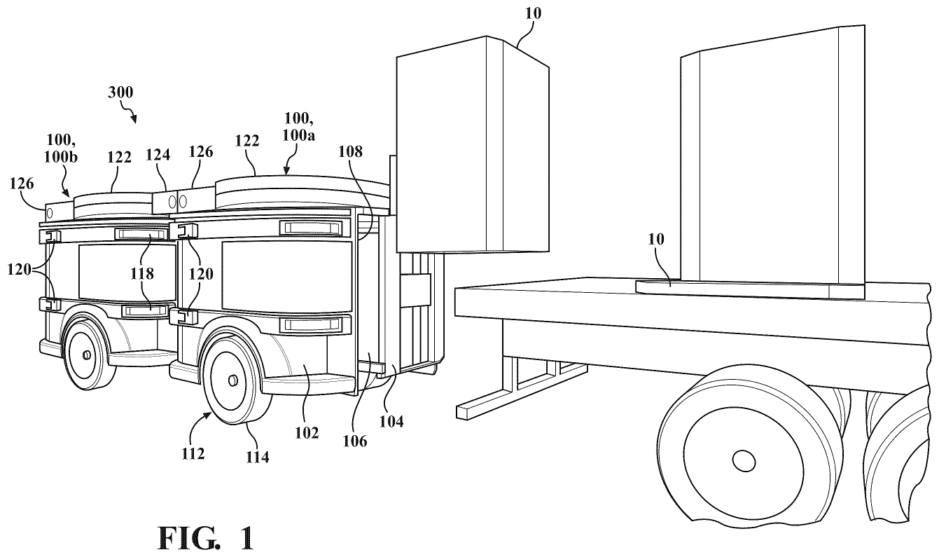

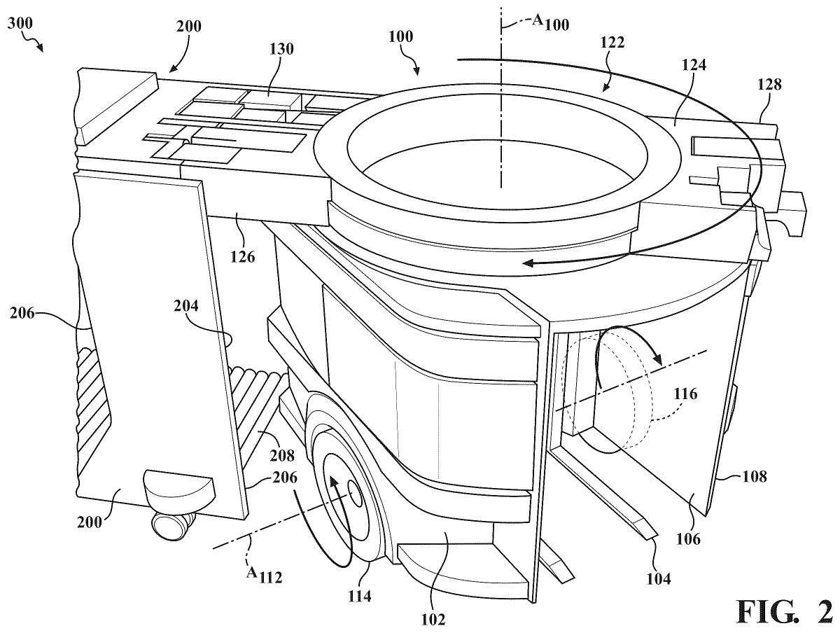

Referring now to the figures and the illustrated configurations depicted therein, a vehicle 100 is configured to lift and carry one or more cargo pallets 10 within an environment and between destinations (FIG. 1). As described further below, the vehicle 100 is configured to accommodate one or more cargo pallets 10, travels freely along a ground or road surface, and may join or couple to other vehicles 100 (e.g., FIG. 1) and/or one or more trailer or linking vehicles 200 (e.g., FIG. 2) to form a road train or train assembly or chain 300. The one or more vehicles 100 and/or trailers 200 of the road train 300 may thus pickup, transport, and drop-off loads of cargo pallets 10 between destinations without the aid of external forklifts or other unloading devices.

Referring to FIGS. 1-4, the vehicle 100 includes a body 102 and a lifting mechanism 104, such as a forklift-style mechanism, attached to the body 102 (FIG. 1). The lifting mechanism 104 is configured to engage and lift or manipulate individual cargo pallets 10, such as for retrieving cargo pallets 10 from the ground surface or a loading area, and the lifting mechanism 104 is configured to hold the cargo pallet 10 within a chamber or cargo area 106 of the vehicle body 102. In the illustrated example, the vehicle body 102 includes a first chamber or cargo area 106, 106a at a first side or front portion of the body 102 and a second chamber or cargo area 106, 106b at an opposite second side or rear portion of the body 102 opposite the first side. Thus, with each cargo area 106 accommodating a respective cargo pallet 10, the load may be relatively evenly distributed at opposite sides of the vehicle 100.

Each cargo area 106 accommodates a respective lifting mechanism 104 that is configured to extend at least partially through an opening 108 in the vehicle body 102, engage and lift the cargo pallet 10, and retract into the cargo area 106 through the opening 108 while carrying the pallet 10 so that the pallet 10 and the lifting mechanism 104 are stowed within the cargo area 106 during travel. For example, each lifting mechanism 104 may be mounted at a rear wall 110 of the respective cargo area 106 (or a center wall of the body 102 separating the first cargo area 106a and the second cargo area 106b) and extendable and retractable through the opening 108 of the cargo area 106 opposite the rear wall 110. In other words, the vehicle 100 includes first and second lifting mechanisms 104 associated respectively with the first cargo area 106a and the second cargo area 106b for lifting and holding first and second cargo pallets 10 within the first and second cargo areas 106a, 106b. With the lifting mechanism 104 extended fully from the cargo area 106, the lifting mechanism 104 may raise or lift above the body 102, such as for loading and unloading cargo pallets 10 from trucks and loading docks (e.g., FIG. 1).

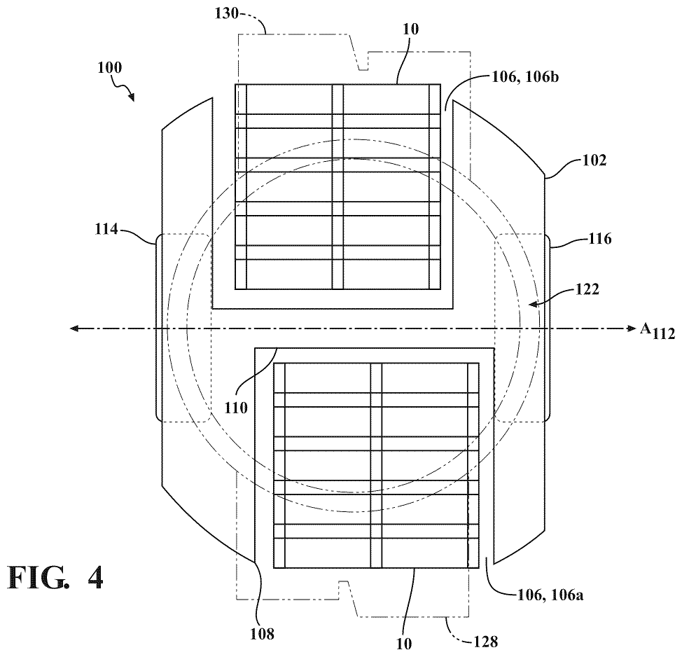

As shown in FIG. 4, the cargo areas 106a, 106b of the vehicle 100 are each configured to accommodate a respective cargo pallet 10 with minimal clearance between internal walls of the body 102 and the pallet 10. Further, the lifting mechanisms 104 are disposed back-to-back within the vehicle body 102 at the rear wall 110 to maximize the cargo volume of the body 102. This minimizes the footprint of the vehicle 100, such that the vehicle 100 may be able to spin or turn 360 degrees within the confines of a typical road lane.

The vehicle 100 further includes a propulsion system 112 having a first independently driven wheel 114 at a third side or left side portion of the vehicle body 102 and a second independently driven wheel 116 at a fourth side or right side portion of the body 102 opposite the third side. The first wheel 114 and the second wheel 116 are suspended at opposite sides of the body 102 and are rotatably driven about a common drive axis A₁₁₂ of the propulsion system 112 that extends across the body 102 and generally parallel to the ground or road surface at which the vehicle 100 is travelling. The vehicle 100 may be substantially symmetrical across the drive axis A₁₁₂ to aid in distributing the load between opposing sides of the vehicle 100. However, and as described further below, the vehicle 100 may not be self-balancing, such that the vehicle 100 is connected to another vehicle 100 or trailer 200 in order to travel along the road.

The independently driven wheels 114, 116 are individually suspended at the body 102 and do not pivot or turn relative to the body 102, such that the propulsion system 112 drives the first wheel 114 and the second wheel 116 independently of one another (e.g., via respective electrically powered motors disposed at the wheels 114, 116) to cause the vehicle 100 to travel in a forward direction of travel (e.g., with the first cargo area 106a facing the direction of travel), in a rearward direction of travel (e.g., with the second cargo area 106b facing the direction of travel), and to spin or turn about a rotational axis A₁₀₀ of the vehicle 100. The rotational axis A₁₀₀ may extend perpendicular to the drive axis A₁₁₂ at or near a center point of the vehicle 100. That is, the propulsion system 112 may drive the first wheel 114 and the second wheel 116 together and in tandem in a first direction or an opposite second direction to cause the vehicle 100 to travel in the forward direction or rearward direction of travel, and the propulsion system 112 may drive the first wheel 114 and the second wheel 116 at different speeds and/or in different directions to cause the vehicle 100 to pivot about the rotational axis A₁₀₀.

To accommodate travel of the vehicle 100 and the road train 300 in both the forward direction of travel and the rearward direction of travel, the vehicle 100 includes a first indicator light or first light sources 118 at the front portion of the body 102 and a second indicator light or second light sources 120 at the rear portion of the body 102. For example, individual light sources may be disposed at opposing sides of the respective openings 108 of the first cargo area 106a and the second cargo area 106b. When the vehicle 100 is travelling in the forward direction of travel, the first light sources 118 may operate as a headlamp of the vehicle 100 and emit white light and the second light sources 120 may operate as a taillamp of the vehicle 100 and emit red light. Based on the vehicle 100 travelling in the rearward direction, the first light sources 118 may switch to operating as the taillamp of the vehicle 100 and emit red light and the second light sources 120 may switch to operating as the headlamp of the vehicle 100 and emit white light. The first light sources 118 and the second light sources 120 may further operate as turn signal indicators of the vehicle 100 and emit amber light or red light in a flashing pattern. For example, the first light sources 118 and the second light sources 120 may include color changing light emitting diodes (LEDs).

When multiple vehicles 100 are connected to form a road train 300, the light sources 118, 120 of each individual vehicle 100 may be operated based on the position of the vehicle 100 within the road train 300. For example, and as shown in FIG. 1, the road train 300 includes a first vehicle 100, 100a in a front or driving position of the road train 300 and a second vehicle 100, 100b in a rear or following position of the road train 300. The first light sources 118 of the front vehicle 100a may operate as the head lamp for the road train 300, the second light sources 120 of the rear vehicle 100b may operate as the taillamp of the road train 300, while the second light sources 120 of the front vehicle 100a and the first light sources 118 of the rear vehicle 100b may not be operated.

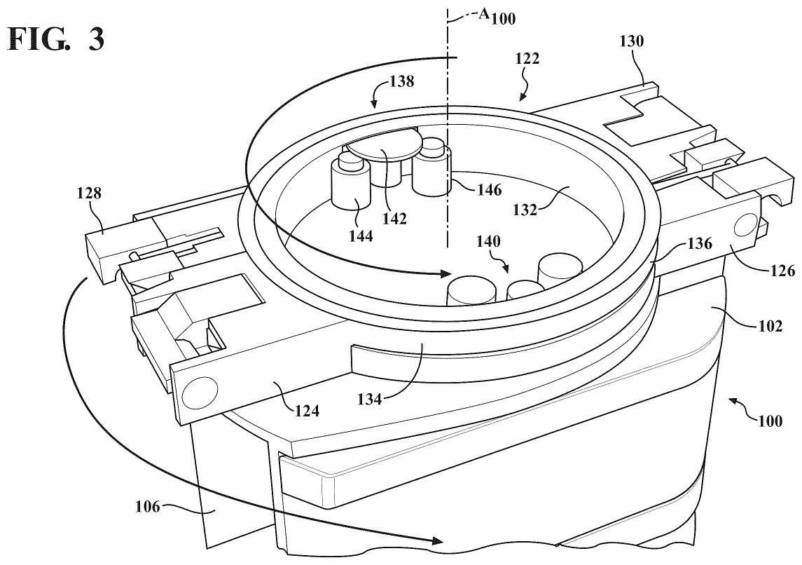

Referring to FIGS. 3 and 4, each vehicle 100 includes a bi-directional hitch assembly 122 disposed at an upper portion of the body 102 above the cargo areas 106 and configured to connect the vehicle 100 to other vehicles 100, trailers 200, and the like. The hitch assembly 122 includes a first connector 124 that is rotatable relative to the body 102 about the rotational axis A₁₀₀ and that is configured to connect the vehicle 100 to one other vehicle 100 or trailer 200, and the hitch assembly 122 includes a second connector 126 that is rotatable relative to the body 102 about the rotational axis A₁₀₀ and that is configured to connect the vehicle 100 to one other vehicle 100 or trailer 200. The first connector 124 includes a first coupler 128 and the second connector 126 includes a second coupler 130, with the first coupler 128 and the second coupler 130 configured to align and receive one another to join two vehicles 100 together (e.g., FIG. 4).

The first connector 124 and the second connector 126 are rotatable relative to the vehicle body 102 and rotatable relative to one another about the rotational axis A₁₀₀. In the illustrated example, the hitch assembly 122 includes a stationary ring 132 that is fixed relative to the vehicle body 102 and a first or upper rotatable ring 134 and a second or lower rotatable ring 136 are concentric to and rotatable about the stationary ring 132. For example, respective ball-bearing interfaces may be disposed between the stationary ring 132 and the first rotatable ring 134 and the second rotatable ring 136. The first connector 124 is connected to and rotatable with the first rotatable ring 134 and the second connector 126 is connected to and rotatable with the second rotatable ring 136.

Thus, with the first connector 124 connected to one vehicle 100 or trailer 200 and the second connector 126 connected to another vehicle 100 or trailer 200, the vehicle body 102 is freely rotatable beneath the bi-directional hitch 122, such as by driving the first wheel 114 and the second wheel 116 in opposite directions. In other words, the body 102 may rotate up to 360 degrees relative to the connectors of the hitch 122. Optionally, the hitch 122 may include a first actuator 138 configured to rotate and/or lock the first connector 124 relative to the body 102 and a second actuator 140 configured to rotate and/or lock the second connector 126 relative to the body 102, such as to position and stabilize the hitch 122 for connection to other vehicles 100 or trailers 200. In the illustrated example, the first actuator 138 and the second actuator 140 are disposed at the upper portion of the body 102 and each include a drive gear 142 engaging the respective rotatable ring 134, 136 through the stationary ring 132, a motor 144 for driving the drive gear 142, and a locking mechanism 146 for locking the drive gear 142. Moreover, the first connector 124 and the second connector 126 may each be rotated relative to the vehicle body 102 and to one another, such as for connecting to additional vehicles 100 or accommodate a turning radius of the road train 300. For example, the first connector 124 may rotate up to 270 degrees or more about the rotational axis A₁₀₀ relative to the second connector 126.

In some examples, the hitch assembly 122 is configured to couple to an accessory attachment 148, such as an articulating arm, a crane, and the like (FIG. 5). That is, with the second connector 126 of the front vehicle 100a of the road train 300 connected to a rear vehicle 100b of the road train 300, the first connector 124 of the front vehicle 100a may be coupled to the accessory attachment 148. The accessory attachment 148 may include a coupler 130 configured to connect to the couplers 128, 130 of the hitch assembly 122. With the accessory attachment 148 (in the illustrated example, an articulating robotic arm) attached to the road train 300, it may be operated, such as to unload or load cargo at the pallet 10.

Because each vehicle 100 includes the two-wheeled propulsion system 112, the road train 300 includes at least two vehicles 100 chained together for stability. As shown in FIG. 1, with the hitch 122 of the front vehicle 100a connected to the hitch 122 of the rear vehicle 100b, the second connector 126 of the front vehicle 100a is coupled to the first connector 124 of the rear vehicle 100b to form the road train 300. The second connector 126 of the rear vehicle 100b may be available to couple to additional vehicles 100, trailers 200 or attachment accessories 148, and the first connector 124 of the front vehicle 100a may not be connected to other vehicles 100 or trailers 200 to allow the lifting mechanism 104 to extend from the cargo area 106 and interact with cargo pallets 10. Each vehicle 100 in the road train 300 may rotate about its rotational axis A₁₀₀ to position both the first cargo area 106a and the second cargo area 106b for receiving cargo pallets 10.

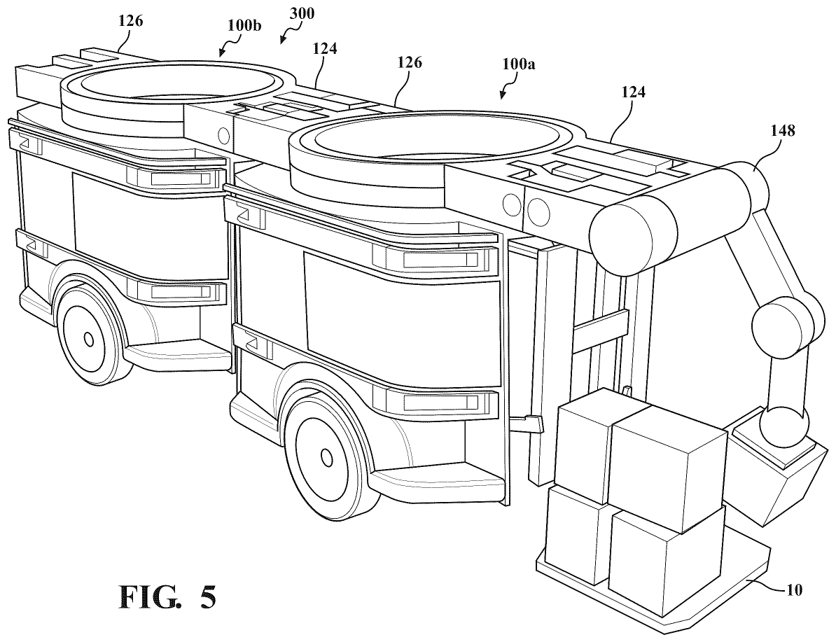

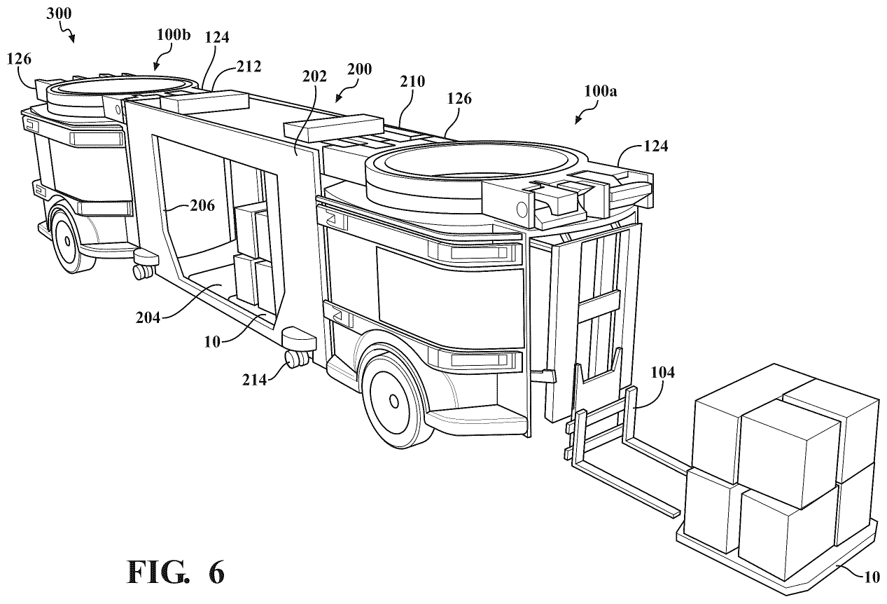

Referring to FIGS. 2 and 6, a trailer or link vehicle or bridge vehicle or cart 200 may be supported between adjacent vehicles 100 of the road train 300. The trailer 200 includes a body 202 having a cargo area or chamber 204 extending between respective openings 206 at a front side, a rear side, and opposing left and right sides of the body 202. The cargo area 204 is configured to receive and hold cargo pallets 10 through the openings 206. For example, the trailer 200 may be configured to accommodate four or more cargo pallets 10. The cargo pallets 10 may be deposited within the cargo area 204 via the retractable lift mechanism 104 of the vehicle 100, such as by rotating the vehicle 100 to face the opening 206 at the end of the trailer 200 and extending the lifting mechanism 104 and cargo pallet 10 through the opening 206. A bottom floor or surface 208 of the trailer 200 may include a conveyor or rolling surface for moving cargo pallets 10 along the length of the trailer 200, such that a cargo pallet 10 may be deposited by the front vehicle 100a at one end of the trailer 200, moved along the length of the trailer 200, and removed from the opposite end of the trailer 200 by the rear vehicle 100b.

The trailer 200 includes a first hitch connector 210 at an upper portion of one end of the trailer 200 and a second hitch connector 212 at an upper portion of the opposite end of the trailer 200, with the first hitch connector 210 and the second hitch connector 212 configured to couple to the hitch assembly 122 of respective vehicles 100. In the illustrated example, the first hitch connector 210 is connected to the coupler 130 of the second connector 126 of the front vehicle 100a and the second hitch connector 212 is connected to the coupler 130 of the first connector 124 of the rear vehicle 100b. The first hitch connector 210 and the second hitch connector 212 may be non-rotatable or fixed relative to the body 202 of the trailer 200.

When the road train 300 is moving, the trailer 200 is suspended between the front vehicle 100a and the rear vehicle 100b, such that the trailer 200 does not contact the ground or road surface. The trailer 200 may include retractable supports or casters 214 that extend from a lower portion of the trailer body 202 to support the trailer 200 when the road train 300 is not moving and/or the trailer 200 is disconnected from the road train 300, such as when the trailer 200 is being loaded or unloaded. Further, with the casters 214 supporting the trailer 200, the casters 214 may be retracted to lower the trailer 200, such as for loading and unloading, or to disconnect the hitch connectors 210, 212 of the trailer from the front vehicle 100a and the rear vehicle 100b.

In some examples, the trailer 200 includes a portion encompassing the floor surface 208 (e.g., a lower portion of the body 202) that extends or lowers to the ground surface. This allows the floor surface 208 to be disposed at or near the ground surface while the trailer 200 remains connected between adjacent vehicles 100. In this example, the casters 214 may be fixed to the lower portion of the trailer 200 to support the lower portion when extended or lowered to the ground surface.

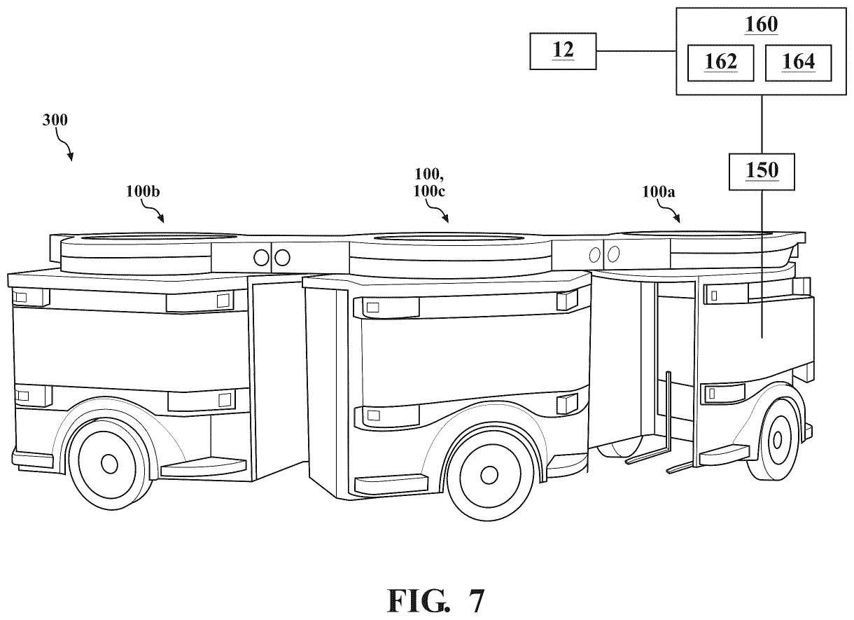

Thus, with one vehicle 100 connected to at least one other vehicle 100, the road train 300 is operable to lift, transport and deposit cargo pallets 10 between destinations. The road train 300 may have any suitable configuration of vehicles 100 and trailers 200, with at least a front vehicle 100a and a rear vehicle 100b, and with one or more trailers 200 optionally disposed between adjacent vehicles 100. For example, FIG. 7 shows the road train 300 having a third or intermediate or middle vehicle 100, 100c disposed between the front vehicle 100a and the rear vehicle 100b.

With the road train 300 formed, the propulsion systems 112 of each vehicle 100 in the road train 300 may cooperate to drive the road train 300. That is, the road train 300 may be driven by simultaneous, collaborative power from the propulsion system 112 of each vehicle 100.

Optionally, the propulsion system 112 of only some vehicles 100 in the road train 300 (e.g., only the front vehicle 100a) may be operated to drive the road train 300. For example, propulsion systems 112 of the intermediate vehicle 100c and the rear vehicle 100b may operate passively (i.e., the independently driven wheels rotate freely and are not driven) so that the front vehicle 100a may act as a locomotive or driver of the road train 300 that pulls the intermediate vehicle 100c and the rear vehicle 100b. In other words, the propulsion system 112 of the front vehicle 100a may drive the independently driven wheels 114, 116 to cause the front vehicle 100a, the intermediate vehicle 100c, and the rear vehicle 100b to move in a direction of travel. In this example, passive vehicles 100 (i.e., where the propulsion system 112 is not being powered to drive the road train 300) may energize the actuators 138, 140 of the hitch assembly 122 to lock the hitch assembly 122 and avoid rotation of the vehicle 100 or to initiate turning or pivoting of the vehicle 100.

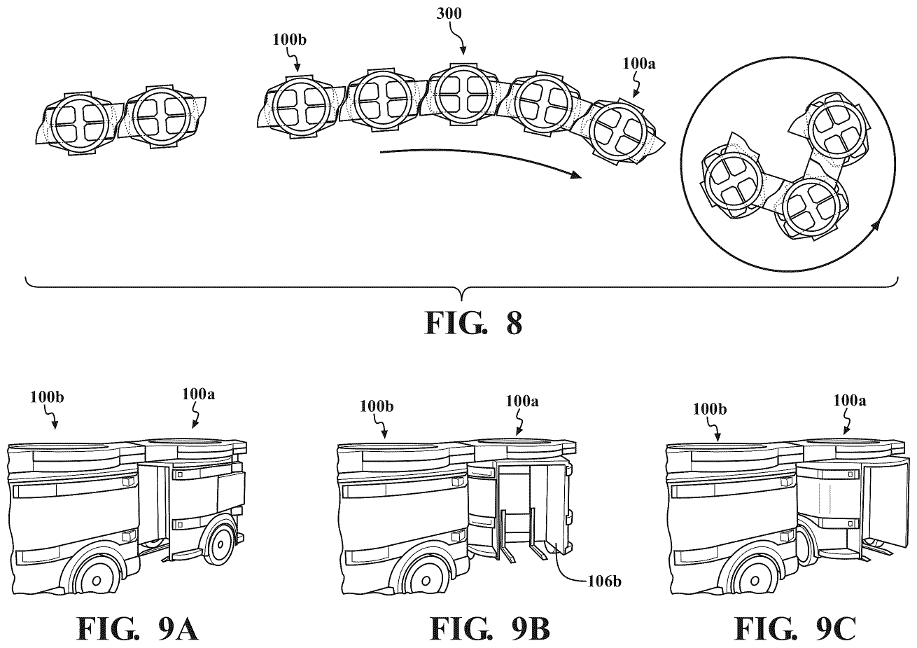

As shown in FIG. 8, driving the road train 300 via only the propulsion system 112 of the front vehicle 100a may cause the road train 300 to turn or pivot in a relatively wider arc, while driving the propulsion systems 112 of each vehicle 100 in the road train 300 may enable a tighter turning radius. Additionally, the hitch assemblies 122 of the respective vehicles 100 may be operated to connect and disconnect groupings of two or more vehicles 100 from the road train 300, as discussed further below.

Referring to FIGS. 9A-9C, the vehicles 100 of the road train 300 may be pivotable relative to one another up to 360 degrees about the rotational axis A₁₀₀. For example, the second or rear cargo area 106b of the first vehicle 100a and the first or front cargo area 106a of the second vehicle 100b may be blocked or inaccessible when each vehicle 100 is facing in a direction of travel of the road train 300 (FIG. 9A). To access the second cargo area 106b of the first vehicle 100a, such as to retrieve a cargo pallet 10 or deposit a cargo pallet 10, the first vehicle 100a may pivot relative to the second vehicle 100b to make the second cargo area 106b accessible.

Operation of the road train 300 (e.g., operating each individual vehicle 100 of the road train 300 and/or operating at least the first vehicle 100a in the front driving position of the road train 300) may be controlled by an onboard, human driver. For example, the vehicle 100 may include a cab configured to accommodate the driver. The cab may be disposed at the front portion of the vehicle body 102 offset from the first cargo area 106a, or the cab may be disposed in place of the first cargo area 106a. Optionally, the cab may be disposed on top of the body 102, such as coupled to the first connector 124 of the hitch assembly 122.

In some examples, the vehicle 100 may be equipped with a sensor system 150 configured to capture sensor data representative of the environment surrounding the vehicle 100 and the road train 300 may be driven at least semi-autonomously and/or operated by a remote user or driver 12 not onboard the vehicle 100 (FIG. 7). The sensor system 150 may include one or more of a camera, a microphone, a radar sensor, an ultrasonic sensor, a lidar sensor, an infrared camera, and the like. Sensor data captured by the sensor system 150 may be transmitted to an electronic control unit (ECU) 160 or control module. The ECU 160 includes electronic circuitry and associated software for operating the vehicle 100 and/or road train system 300 based on processing of the captured sensor data and/or based on inputs provided by the remote user 12. That is, the ECU 160 includes data processing hardware 162 and memory hardware 164 in communication with the data processing hardware 162. The memory hardware 164 stores instructions that, when executed on the data processing hardware 162, cause the data processing hardware 162 to perform operations. For example, the ECU 160 stores instructions for controlling operation of the vehicle 100 and/or other vehicles 100 of the road train 300 as the road train 300 travels within and between environments. The ECU 160 may be disposed at the vehicle 100 or disposed remote from the vehicle 100 and in wireless communication with the vehicle 100.

When the road train 300 is driven by the remote user 12, sensor data captured by the sensor system 150 at one or more vehicles 100 of the road train 300 is processed to provide video images, audio outputs, and other sensory information regarding the environment of the road train 300 to the remote user 12. Thus, the user 12 may provide inputs (e.g., via a remote input device or control panel) to at least partially control operation of the road train 300. Similarly, the sensor data captured by the sensor system 150 may be processed to provide at least partially autonomous control of the road train 300. In some examples, the vehicles 100 of the road train 300 may be configured for full autonomous operation, such that the vehicles 100 may pick up cargo pallets 10, connect together to form a road train 300, disconnect from road trains 300, and drop off cargo pallets 10 with minimal to no input from human operators.

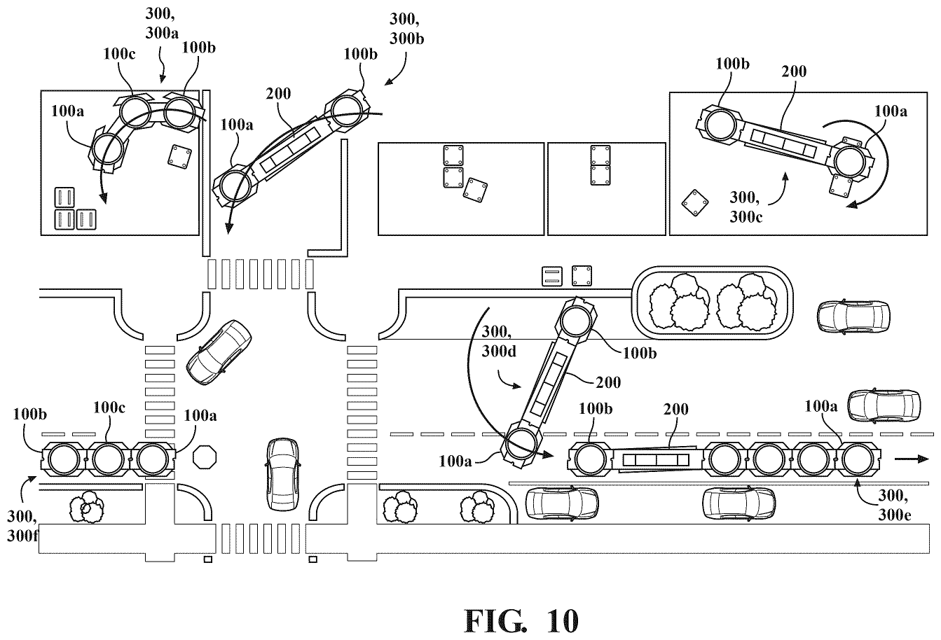

FIG. 10 depicts an example environment in which several road trains 300 of varying length and configuration operate to pick up and deliver cargo pallets 10. It should be understood that the actions performed by the vehicles 100 and trailers 200 of the road train 300 are non-limiting and may not reflect each action possible. For example, a first road train 300, 300a may include a front vehicle 100a, a rear vehicle 100b, and an intermediate vehicle 100c and does not include a trailer 200 so that the road train 300a may maneuver within tight spaces (e.g., within manufacturing or warehouse environments). A second road train 300, 300b, a third road train 300, 300c, and a fourth road train 300, 300d may each include a trailer 200 between the front vehicle 100a and the rear vehicle 100b to combine the capabilities of trucks, trailers, conveyors and forklifts all in one road train. As demonstrated by the third road train 300c, the vehicles 100 coordinate to maintain balance across multiple wheels, with the trailer 200 translating cargo to the vehicles 100 for unloading (e.g., by operating the conveyor floor 208 of the trailer 200). The vehicles 100 pivot to load and unload from the end of the road train 300.

Vehicles 100 may join or disconnect from the road train 300 based on final destinations of the cargo pallets 10 carried by the vehicles 100 and/or trailers 200. For example, the front vehicle 100a of the fourth road train 300d may drive the fourth road train 300d to connect to a rear vehicle 100b of a fifth road train 300, 300e currently in motion. That is, the hitch assembly of the front vehicle 100a of the fourth road train 300d may operate to connect to the hitch assembly of the rear vehicle 100b of the fifth road train 300e. The fourth road train 300d may join to the fifth road train 300e based a common final destination associated with one or more cargo pallets 10 at the fifth road train 300e and one or more cargo pallets 10 at the fourth road train 300d and/or based on a destination of one or more cargo pallets 10 at the fourth road train 300d being located at or near the route of the fifth road train 300e. When connected, the front vehicle 100a of the fourth road train 300d may relinquish driving control to the front vehicle 100a of the fifth road train 300e.

A sixth road train 300, 300f was previously connected to the fifth road train 300e, but the front vehicle 100a of the sixth road train 300f disconnected from the rear vehicle 100b of the fifth road train 300e so that the sixth road train 300f could stop at a stop light. After the stop light changes to allow the sixth road train 300f to move, the sixth road train 300f may catchup and reconnect to the fifth road train 300e. Thus, the road train 300 may separate or segment itself to accommodate traffic laws.

Operation of the plurality of road trains 300 disposed within an environment may be controlled by a remote controller controlling operation of each vehicle 100. Optionally, each vehicle 100 may include its own individual control module for interacting with other vehicles 100 and trailers 200 and moving within the environment.

In other words, the modular road train system 300 includes a road train 300 of variable length including two or more independently powered vehicles 100 connected overhead to one another and/or to one or more motion-dependent, non-powered trailers 200 via the bi-directional hitch assembly 122. The interlocking hitches 122 structurally connect each vehicle 100 and trailer 200 in the road train 300. Moreover, each vehicle 100 can independently rotate 360 degrees about its center rotational axis A₁₀₀ and steering, body pivoting, vehicle direction, speed and balance of the road train 300 are provided by independent rotational movement of the two-wheeled propulsion system 112 of at least the forward most vehicle 100 in the road train 300. The road train 300 may have increased capacity with non-motorized trailers 200 supported overhead between vehicles 100 by the hitch assemblies 122 of the vehicles 100. Cargo may be transferred along the length of the road train 300 from one vehicle 100, through a trailer 200 and to the next vehicle 100 so that a stationary road train 300 may be used as a conveyor.

The road train 300 may be guided by a driver utilizing an add-on driver cab, or autonomously, or by remote users 12 provided with complete visual and audio information relayed to them by the vehicle 100 itself through cameras, microphones and other sensors of the sensor system 150. Further, the vehicles 100 may have advanced detection capabilities that warn and can automatically stop the vehicle 100 if they sense a potential collision.

Overhead, bi-directional hitch assemblies 122 at each vehicle 100 rotate around stacked turret rings to allow the vehicle 100 to pivot 360 degrees, enabling turning of the road train 300 at any angle and the ability for cargo pallets 10 to be exchanged between vehicles 100 and trailers 200. The turret rings may be free turning during normal operation of the vehicle 100 and locked in place to prevent unintended turning of the vehicle 100, such as due to loss of traction by the propulsion system 112.

Thus, the modular road train system 300 includes any number of two or more connected, two-wheel-powered vehicles 100 and extra-capacity bridges or trailers 200 to achieve the combined functionality of forklifts, trucks and trailers. The road train system 300 provides improved efficiency by combining the functions of lifting and transporting palleted cargo, saving time spent lifting, loading and unloading the cargo. The individually driven two-wheeled propulsion system 112 minimizes the footprint of the vehicle 100 and eliminates or reduces the need for complicated steering apparatuses. Moreover, because the vehicle 100 includes an integrated forklift or lifting mechanism 104, the road train 300 may pick up and drop off cargo pallets 10 at any location without the need for a separate forklift present. The modular ability to vary the length and capacity of the road train 300 provides utilization efficiency over fixed-sized trucks and trailers. Further, increasing the size of a road train 300 may reduce labor requirements as the longer chains of vehicles 100 and trailers 200 may be driven over distance with reduced driving resource needs.

Use of road trains 300 recues the time and labor involved in moving cargo pallets 10 over distances and eliminates or reduces the need for transferring the cargo pallets 10 between shelves, loading docks, trailers, trucks and forklifts. Other aspects of the modular road train system 300 may expand the capacity of the road train 300 and offer covered storage and retrieval of the cargo pallets 10. The modular nature of the road train 300 reduces the cost of the driver or AV system by chaining together any number of vehicles 100 and trailers 200 for longer segments of the route, and the road train 300 may be sized appropriately based on the cargo being transported. The configuration of the vehicle 100 allows the majority of its footprint to be dedicated to cargo space, with the configuration of the propulsion system providing greater reliability than traditional trucks or forklifts.

The hitch assembly 122 and vehicle 100 may utilize characteristics of the hitch assemblies and systems described in U.S. patent application Ser. No. ____, filed ____, and titled BI-DIRECTIONAL HITCH WITH ACTIVE LATERAL ANGLE CONTROL (Attorney Docket No. P108767-PRI-NP-US01), which is incorporated herein by reference in its entirety.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a body including a chamber and a lifting mechanism, the lifting mechanism disposed at least partially within the chamber and configured to engage and lift a cargo pallet, and the chamber configured to receive the cargo pallet through an opening in the body and accommodate the cargo pallet and the lifting mechanism within the chamber;
a propulsion system including a first independently driven wheel and a second independently driven wheel disposed at opposing sides of the body, the propulsion system configured to drive the first wheel and the second wheel to cause the vehicle to pivot about a rotational axis of the vehicle; and
a bi-directional hitch disposed at an upper portion of the body and including a first connector and a second connector, the first connector and the second connector configured to pivot relative to one another and relative to the body about the rotational axis of the vehicle, each of the first connector and the second connector configured to attach the vehicle to one selected from the group consisting of (i) another vehicle and (ii) a trailer.

2. The vehicle of claim 1, wherein the lifting mechanism is configured to extend at least partially through the opening in the body and away from the chamber.

3. The vehicle of claim 2, wherein, with the vehicle attached to the trailer, the lifting mechanism is configured to extend through the opening in the body and at least partially through an opening in the trailer to deposit the cargo pallet within an interior portion of the trailer.

4. The vehicle of claim 1, wherein the body includes a second chamber and a second lifting mechanism disposed at least partially within the second chamber and configured to engage and lift a second cargo pallet, the second chamber configured to receive the second cargo pallet through a second opening in the body and accommodate the second cargo pallet and the second lifting mechanism within the second chamber.

5. The vehicle of claim 1, wherein the propulsion system is configured to drive the vehicle in a forward direction of travel and a rearward direction of travel.

6. The vehicle of claim 5, wherein a first indicator light is disposed at a first exterior side of the body and a second indicator light is disposed at a second exterior side of the body opposite the first exterior side, the first indicator light and the second indicator light switchable between operating as a headlamp for the vehicle and operating as a taillamp for the vehicle based on a current direction of travel of the vehicle.

7. The vehicle of claim 1, wherein each of the first connector and the second connector is further configured to attach to an accessory attachment.

8. The vehicle of claim 1, wherein the vehicle is configured to attach to the selected one of the other vehicle and the trailer to form a road train, and the propulsion system of the vehicle is configured to drive the road train in a direction of travel.

9. The vehicle of claim 1, wherein the body includes a cab configured to accommodate a driver of the vehicle.

10. The vehicle of claim 1, further comprising a sensor system configured to capture sensor data at the vehicle to enable at least partially autonomous driving of the vehicle.

11. A road train comprising:
a first vehicle and a second vehicle connected to one another, each of the first vehicle and the second vehicle including:
a body including a chamber and a lifting mechanism, the lifting mechanism disposed at least partially within the chamber and configured to engage and lift a cargo pallet, and the chamber configured to receive the cargo pallet through an opening in the body and accommodate the cargo pallet and the lifting mechanism within the chamber;
a propulsion system including a first independently driven wheel and a second independently driven wheel disposed at opposing sides of the body, the propulsion system configured to drive the first wheel and the second wheel to cause the respective vehicle to pivot about a rotational axis of the vehicle; and
a bi-directional hitch disposed at an upper portion of the body and including a first connector and a second connector, the first connector and the second connector configured to pivot relative to one another and relative to the body about the rotational axis of the respective vehicle, each of the first connector and the second connector configured to attach the respective vehicle to one selected from the group consisting of (i) another vehicle and (ii) a trailer; and
with the first vehicle disposed in a front position of the road train, at least the propulsion system of the first vehicle is configured to drive the road train in a direction of travel.

12. The road train of claim 11, wherein the first vehicle is attached at a first connector of the trailer and the second vehicle is attached at a second connector of the trailer.

13. The road train of claim 12, wherein the trailer is supported between the first vehicle and the second vehicle.

14. The road train of claim 13, wherein the trailer includes a support element configured to extend from the trailer and support the trailer at a ground surface, the support element including at least one selected from the group consisting of (i) a caster, (ii) a support leg, and (iii) a lower portion of the trailer.

15. The road train of claim 11, wherein the respective propulsion systems of the first vehicle and the second vehicle are configured to drive the road train in the direction of travel.

16. A system comprising:
a first vehicle and a second vehicle connected to one another in a road train, each of the first vehicle and the second vehicle including:
a body including a chamber and a lifting mechanism, the lifting mechanism disposed at least partially within the chamber and configured to engage and lift a cargo pallet, and the chamber configured to receive the cargo pallet through an opening in the body and accommodate the cargo pallet and the lifting mechanism within the chamber;
a propulsion system including a first independently driven wheel and a second independently driven wheel disposed at opposing sides of the body, the propulsion system configured to drive the first wheel and the second wheel to cause the respective vehicle to pivot about a rotational axis of the vehicle; and
a bi-directional hitch disposed at an upper portion of the body and including a first connector and a second connector, the first connector and the second connector configured to pivot relative to one another and relative to the body about the rotational axis of the respective vehicle, each of the first connector and the second connector configured to attach the respective vehicle to one selected from the group consisting of (i) another vehicle and (ii) a trailer; and
memory hardware storing instructions that, when executed on data processing hardware in communication with the memory hardware, cause the data processing hardware to perform operations including:
with the first vehicle disposed in a front position of the road train, operating at least the propulsion system of the first vehicle to drive the road train in a direction of travel.

17. The system of claim 16, wherein the operations further include, with the second vehicle in a rear position of the road train, operating the second connector of the second vehicle to attach the second vehicle to the selected one of the other vehicle and the trailer based on a destination of the selected one of the other vehicle and the trailer.

18. The system of claim 16, wherein the operations further include, with the second vehicle in a rear position of the road train, operating the first connector of the second vehicle to detach the second vehicle from the road train based on a destination of the second vehicle.

19. The system of claim 16, wherein the operations further include, with the first vehicle disposed in the front position of the road train, operating the first connector of the first vehicle to attach the first vehicle to another vehicle and operating at least a propulsion system of the other vehicle to drive the road train in the direction of travel.

20. The system of claim 16, wherein the operations include operating the respective propulsion systems of the first vehicle and the second vehicle to drive the road train in the direction of travel.
